(19) United States
(12) Patent Application Publication
(10) Pub. No.: US 2018/0272387 A1
(43) Pub. Date: Sep. 27, 2018

(54) METHOD OF REMOVING THERMOPLASTIC ADHESIVE ON FABRIC

(71) Applicant: Keystone Specialty Chemicals LLC, Hillsborough, NJ (US)

(72) Inventors: Leahann Iannotta, Wayne, PA (US); Rajesh Pazhianur, Belle Mead, NJ (US)

(21) Appl. No.: 15/926,042

(22) Filed: Mar. 20, 2018

Related U.S. Application Data
(60) Provisional application No. 62/474,441, filed on Mar. 21, 2017.

(51) Int. Cl. B08B 3/08; C11D 7/26; C11D 11/00

(52) U.S. Cl. CPC B08B 3/08; C11D 11/0017; C11D 7/261

(57) ABSTRACT

Provided are methods for dissolving or removing adhesive and decorative elements on fabric or garments that are adhesively bonded by thermoplastic adhesive.

### PRIORITY

This application claims priority to U.S. Provisional Application No. 62/474,441, filed Mar. 21, 2017, entitled “Method of Removing Thermoplastic Adhesive on Fabric”, the entire disclosure of which is incorporated herein by reference for all purposes.

### BACKGROUND

Jewels, mirrors, beads, rhinestones and other decorative elements are regularly used to embellish or accent an article of clothing or accessory transforming it into something sparkling, elegant, sassy or stylish. For example, commercially available rhinestones are typically made out of rock crystal, glass or acrylic and have pre-applied heat-activated adhesives on one side that bond or stick to fabric or item of clothing.

Equipment such as heat applicator wands are known for applying decorative elements using heat-activated adhesives. The wand can have different sized tips for different sized rhinestones. The user utilizes the wand to place one rhinestone at a time on a fabric or material in the position he or she desires. Heat from the wand activates (melts) the adhesive on the rhinestone to stick the rhinestone to the fabric or material. If placement of decorative elements one at a time is tedious, decorative elements can also be purchased in pre-arranged patterns on sheets and the entire pre-arranged pattern can be affixed to fabric in a single application.

While heat-activated adhesives are advantageous because they allow for “permanently” and quickly affixing the decorative element onto the fabric, they can also pose problems. Removal or repositioning of the decorative element is not only difficult; it may not completely remove the adhesive and may destroy or damage the underlying fabric such that the fabric can no longer be used, adding cost to the process.

### SUMMARY

Applicants have unexpectedly discovered, after testing numerous solvents, an adhesive remover that is effective at completely removing thermoplastic adhesive on fabric with minimal or no damage to the fabric as viewed by the unaided eye. The adhesive remover is also effective at removing decorative elements bonded to fabric using thermoplastic adhesive.

The following description relates to a method of removing adhesive, decorative elements adhesively bonded onto fabric, or both adhesive and decorative elements from a fabric.

In one aspect, the invention relates to a method of removing thermoplastic adhesive on fabric, the method comprising:
a. providing fabric that includes thermoplastic adhesive;
b. contacting the fabric with an adhesive remover that comprises an aromatic solvent; and
c. dissolving the adhesive.

In another aspect, the invention relates to a kit for decorating fabric, the kit comprising:

plurality of decorative elements to adhesively bond onto fabric; thermoplastic adhesive for bonding the decorative elements onto the fabric; and adhesive remover.

### BRIEF DESCRIPTION OF THE DRAWINGS

FIG. 1 is illustrates an exemplary decorative element.

FIG. 2 is a digital image of a fabric treated with a test solvent.

FIG. 3 is a digital image of a fabric treated with phenyl ethyl alcohol.

FIG. 4 is a digital image of without any adhesive remover.

FIG. 5 is a digital image of spot treatment of a portion of a design.

FIGS. 6 and 7 are digital images of the rhinestones removed 5 minutes after application of the adhesive remover as shown in FIG. 5.

### DETAILED DESCRIPTION

“Fabric” as used herein refers to pliable, absorbent material made usually by weaving, felting, or knitting natural or synthetic fibers and filaments.

“Spot treatment” or “spot application” as used herein refers to a localized application onto a portion of fabric or garment and does not include application to an entire fabric or garment.

“Thermoplastic” as used herein refers to polymers that reversibly soften or melt and become pliable or flowable when heated to a temperature above a softening temperature characteristic of the material, and that will re-solidify upon cooling to a temperature that is below the softening temperature. Preferred thermoplastic polymers may be heated to reversibly soften or melt, then cooled and re-solidified, repeatedly, without substantial degradation of the polymer. The term “thermoplastic” does not encompass polymers that are thermoset.

“Thermoplastic adhesive” as used herein refers to adhesive based on thermoplastic.

“Thermoset adhesive” as used herein refers to polymers that form permanent, heat-resistant, insoluble bonds that cannot be reversibly modified using heat, without degradation.

“Unaided eye” as used herein refers to visual perception without the assistance or help of a magnifying or light-collecting optical device such as a telescope or microscope. Vision corrected to normal acuity or clarity using corrective lenses is considered unaided.

Disclosed is an adhesive remover and methods of using the adhesive remover to completely remove thermoplastic adhesive and optionally to remove adhesively-bonded decorative elements in an easy, non-destructive or non-damaging manner. The adhesive remover is effective for dissolving the thermoplastic adhesive allowing easy removal of the adhesive, decorative elements bonded to fabric by the adhesive, or both, such that adhesive is completely removed with no remaining adhesive residue that would be visible to the unaided eye on the fabric or garment. The adhesive remover also does not damage the fabric or garment as is visible by the unaided eye such as cause discoloration, shrinkage, or stretching of the fabric or garment.

The inventors have discovered that aromatic solvents are suitable adhesive removers for removing decorative elements bonded or glued to fabric and garment as well as the adhesive used to bond the decorative elements. The adhesive remover when applied to fabric or garment allows for removal of the decorative element with minimal pulling or distortion of the fabric and minimal damage of the fabric by shrinkage, discoloration, stretching or other damage to the fabric. The adhesive remover is most suitable when thermoplastic adhesives are used.

Suitable aromatic solvents that can be used as the adhesive remover include arylalkyl alcohols having the formula:

AR—R—OH;

wherein R is a C1-C8 alkyl divalent linking group; and

AR is

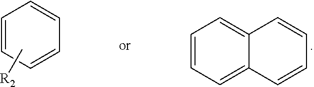

In some aspects, the alkyl groups include methyl, ethyl, propyl, butyl, hexyl, octyl and the aryl groups include phenyl and naphythl. Preferred arylalkyl groups include phenmethyl, phenethyl, phenpropyl, and phenbutyl; examples of alkylaryl groups also include cumenyl, mesityl, tolyl, and xylyl; and alkoxy groups include methoxy, ethoxy, butoxy, and propoxy.

In some aspects, the aromatic solvent can include phenyl alkyl alcohols. Exemplary phenyl alkyl alcohols include phenyl ethyl alcohol, phenyl propyl alcohol, benzyl alcohol, 4-(2-hydroxyethyl) phenol, 2-phenylethyl benzoate, 2-phenylethyl toluate or 2-phenylethyl phthalate.

While the adhesive remover can be entirely (e.g. 100%) aromatic solvent, the adhesive remover can contain other solvents (e.g., co-solvents), surfactants, and materials that do not affect the adhesive remover's ability to completely remove adhesive, decorative elements, or both. The adhesive remover can contain at least 50, 60, 70, 80, 90, 95, 99, or 100 wt % aromatic solvent based on the total weight of the adhesive remover.

The adhesive remover may consist of aromatic solvent as described herein, meaning that the adhesive remover is 100% aromatic solvent as described herein.

The adhesive remover may also consist essentially of aromatic solvent as described herein. The adhesive remover that consists essentially of specified materials is one that contains not more than 5 weight percent, e.g., less than 2 weight percent, preferably less than 1, 0.5, or 0.1 weight percent of other materials or ingredients (e.g., water, co-solvents, surfactants or other materials not affecting the adhesive remover's ability). For example, an adhesive remover that consists essentially of phenyl ethyl alcohol, contains not more than 5 weight percent, e.g., less than 2 weight percent, preferably less than 1, 0.5, or 0.1 weight percent of materials or ingredients other than the phenyl ethyl alcohol.

### Adhesive

The adhesive remover is suitable for dissolving or removing adhesive and decorative elements adhered or bonded to fabric using thermoplastic adhesives. Exemplary thermoplastic adhesives include nitrocellulose, polyvinyl acetate, vinyl acetate-ethylene copolymer, polyethylene, polypropylene, polyamides, polyesters, acrylics, cyanoacrylics, polyurethanes, variety of block copolymers and elastomers such as butyl rubber, ethylene-propylene copolymer, and styrene-butadiene rubber.

Other thermoplastic based adhesive include adhesive referred herein as hot-melt or hotfix.

The adhesive remover is also suitable for removing decorative elements that were affixed to fabric or garments using adhesive selected from ethylene-vinyl acetate copolymer resin, modified ethylene acetate vinyl copolymer resin, polyethylene, polypropylene, polyamide, polyester, polyvinyl chloride, or derivatives thereof, or mixtures thereof.

The adhesive remover is also suitable for removing adhesive, decorative elements or both, where the decorative element can be affixed to fabric or garments using commercially available adhesives such as Beacon, Gem-Tac, E-6000, Devcon epoxies available from ITW Devcon Danvers, Massachusetts, ALEENE available for Gaunt Industries, Inc., Scotch Weld DP 610 available from 3M, Konstruivit, adhesive available from Chrisanne Clover, Bostik 1475 available from Bostik, and any glue suitable for the hotfix process of affixing decorative elements.

### Decorative Elements

Exemplary decorative elements that can be affixed or bonded with thermoplastic adhesives to fabric include, but are not limited to jewels, gems, gemstones, rhinestones, Czech rhinestones, lead crystal and glass pieces or glass elements, polished and unpolished glass crystals, faceted crystal, wood, beads, plastics, stones, painted objects, gold other various metallic particles metal compositions of various shapes, forms, sizes and types. Decorative elements may also include more complex elements, such as LEDs, or lighting componentry, sensor materials, and the like.

The decorative elements can be provided with pre-applied adhesive. In other aspects, the thermoplastic adhesive is supplied separately from the decorative elements. Whether the decorative element is bonded to fabric via pre-applied thermoplastic adhesives on decorative elements or separately supplied thermoplastic adhesives, suitable equipment for applying the decorative element on fabric such as a heat wand can be used.

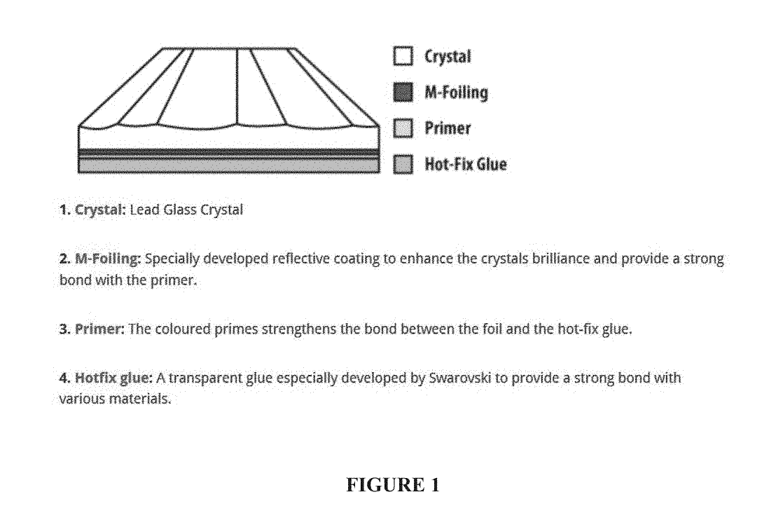

Decorative elements further include rhinestones and crystals created by the Swarovski Company, such as SWAROVSKI ELEMENTS™ and SWAROVSKI™ hotfix crystal or SWAROVSKI™ hotfix rhinestones. The SWAROVSKI™ hotfix crystals are multi-faceted on one side and flat backed on the opposite side. For examples, FIG. 1, illustrates a SWAROVSKI™ hotfix rhinestone. The flat side can be pre-applied with a thermoplastic adhesive or any adhesive that can be heated within approximately 20 seconds and fully hardened within 24 hours.

The multifaceted side is typically made from lead crystal, which is glass with lead added to it to produce a higher degree of shine. Some Swarovski rhinestones feature between 8 and 14 facets. Rhinestones may also be called Austrian crystals and feature a wide variety in choices. Czech rhinestones or glass elements refer to a type of decorative material that is made from pure glass or from lead crystal. These rhinestones have up to eight facets, with one large, flat central facet surrounded by smaller facets.

The adhesive remover and method can be used to remove the adhesive, decorative elements, or both from fabric that include cotton, wool, polyesters, cotton/wool blends, cotton/polyester blends, silk, toile, jersey and denim. The adhesive remover can also be used to remove thermoplastic adhesive and affixed decorative elements from fabrics fashioned into various articles of clothing or garments and also includes fabric that can be fashioned into any particular furniture. For example, articles of clothing include shirts, pants, socks, hats, caps, underwear and the like; and furniture include sofas, bed sheets, pillow cases, table cloths, curtains and the like. It should be understood that the adhesive remover can be used on any fabric or material onto which a decorative element is affixed using thermoplastic adhesives.

### Method of Use

Commercially available decorative elements such as SWOROSKI hotfix (thermoplastic) crystals are typically applied via a method referred to as hotfix application. The hotfix crystals typically have pre-applied adhesive that can be heated using a heat applicator wand. The wand is then used to position the crystal in a desired positon and arrangement onto the fabric.

If desired, the decorative elements can be affixed to fabric using heat transfer sheets that have adhesive on one side and pre-arranged rhinestone patterns on the other side. The sticky side of the sheet is then placed on fabric and heat is used to activate the adhesive and apply the entire pre-arranged rhinestone pattern in a single application.

The adhesive remover can be applied to fabric such that it breaks down or dissolves the adhesive thereby allowing the decorative element to be easily lifted or removed from the fabric and completely removing any adhesive that may be visually present. Such adhesive remover not only allows for the complete removal of the adhesive, it does so with no or minimal damage as viewed by the unaided eye.

It should be understood that the adhesive remover is suitable for removing any thermoplastic adhesive on fabric. If a decorative element is bonded on fabric with a thermoplastic adhesive, the decorative element along with the adhesive can be removed using the adhesive remover. Optionally, the decorative element can be first removed by heat, such as with a heat wand or the like. Once the decorative element is removed by heat, the adhesive that remains on the fabric can be removed by the adhesive remover.

In some aspects, before the adhesive remover is used, it may be desirable to mask or cover the fabric area where the adhesive remover is not desired. After the area is masked or covered, the adhesive remover can be applied to the desired decorative element, adhesive, or both to remove the decorative element, adhesive, or both.

It is to be understood that the length of time needed to remove the adhesive, adhesively-bonded decorative element, or both will vary and depends upon several factors, including the type of adhesive material being removed, its age and the permeability of the underlying fabric to the adhesive remover. The length of time should be sufficient to permit the solvent to soften or dissolve the adhesive thereby allowing the adhesive, decorative element, or both adhesive and decorative element to fall off the fabric or at least be able to be removed with minimal force and damage to the fabric (e.g. bleach, shrink or stretch), leaving no adhesive or adhesive residue. Suitable times used for contacting the adhesive remover with the fabric include at least about 0.1 hours, 0.25 hours, 0.5 hours, 1 hour, 2 hours and up to 24 hours, but not so long that the adhesive remover becomes substantially dry.

Suitable application of the adhesive remover is by soaking, spot treating or spot application, spraying, brushing, and coating. When spot treating or spot applying the adhesive remover, any suitable amount that can affectively remove the adhesive, decorative element, or both that does not affect the surrounding decorative elements is desirable. For example, spot treating can be carried out using about 0.25 milliliters to 2 milliliters, or from about 0.5 milliliters to 1 milliliters.

The adhesive remover can contact the fabric at room temperature. In some aspects, the adhesive remover can contact the fabric at temperatures in the range from about 18° C. to about 30° C., about 20° C. to about 30° C., about 20° C. to about 25° C., or about 18° C. to about 25° C. It is preferable not to use heat when using the adhesive remover because heat could re-heat the thermoplastic adhesive. While spot heating (e.g., to greater than 162° C.) have been used to remove bonded decorative elements, heat can affect the surrounding decorative elements that may not need to be removed.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Fabric strips with Hotfix rhinestones bonded to the fabric were each soaked in separate vials containing different test solvents. The soaked fabric was held in a vial for 24 hours before being rinsed with water to remove solvent residue. Below is a list of solvents tested for removal of the adhesive and the rhinestone:

1. Hexyl carbitol

2. Glycol ether DB

3. Sulfolane

4. Gamma Valerolactone

5. N,N-dimethylformamide

6. Alcohol, 95%

7. Dipropylene glycol normal butyl ether (DPNB)

8. Dipropylene glycol normal (DPN)

9. 1-butanol

10. N-octyl pyrrolidone

11. N-methyl pyrrolidone (NMP)

12. Acetone

The solvents were evaluated for whether the rhinestones could be removed with minimal force, with no adhesive left on the fabric and no damage to the fabric such as discoloration, shrinkage, stretching or any damage that is visible to the unaided eye.

Some solvents tested damaged the fabric by shrinking, discoloring, or dissolving the fabric entirely.

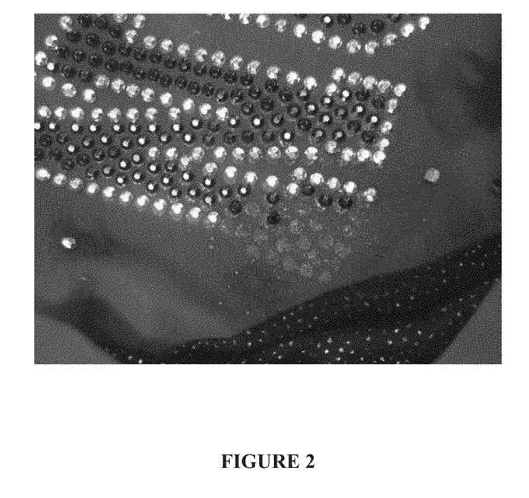

Few other solvents were found that loosen the rhinestones, but the adhesive was still left on the garment. For example, when NMP was used as the solvent, it loosened the rhinestones, allowing them to be peeled them off, but the garment was damaged. FIG. 2 shows the garment after treatment with NMP.

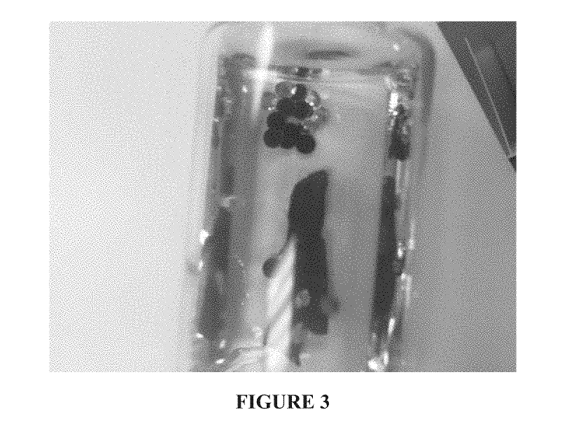

When the solvent phenyl ethyl alcohol was used, it weakened and ultimately dissolved the hot fix/hot melt adhesive without damaging fabric by shrinking, weakening of fibers or discoloring the fabric. The rhinestones were removed from the garment with minimal pulling/distortion of the fabric and no adhesive or adhesive residue was left on the fabric as can be seen with the unaided eye. FIG. 3, shows the rhinestones fallen off the fabric entirely when the image was taken 24 hours later.

### Example 2

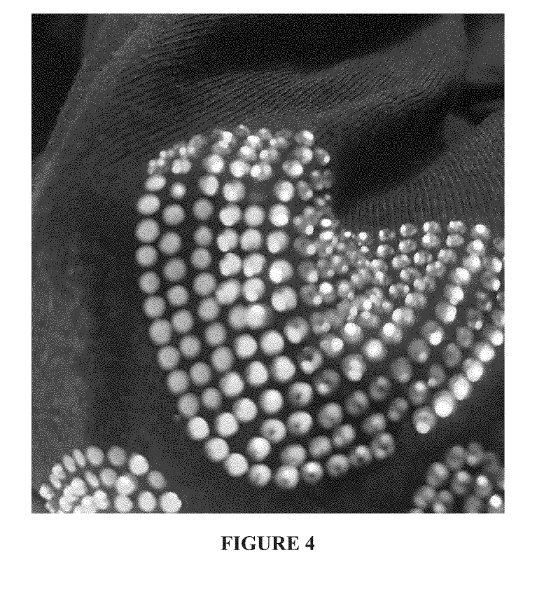

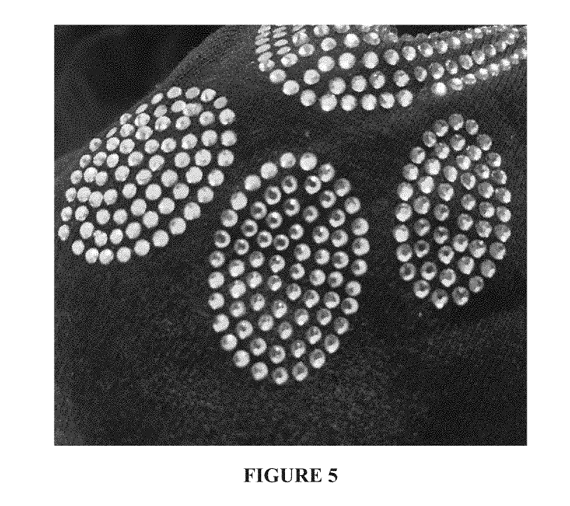

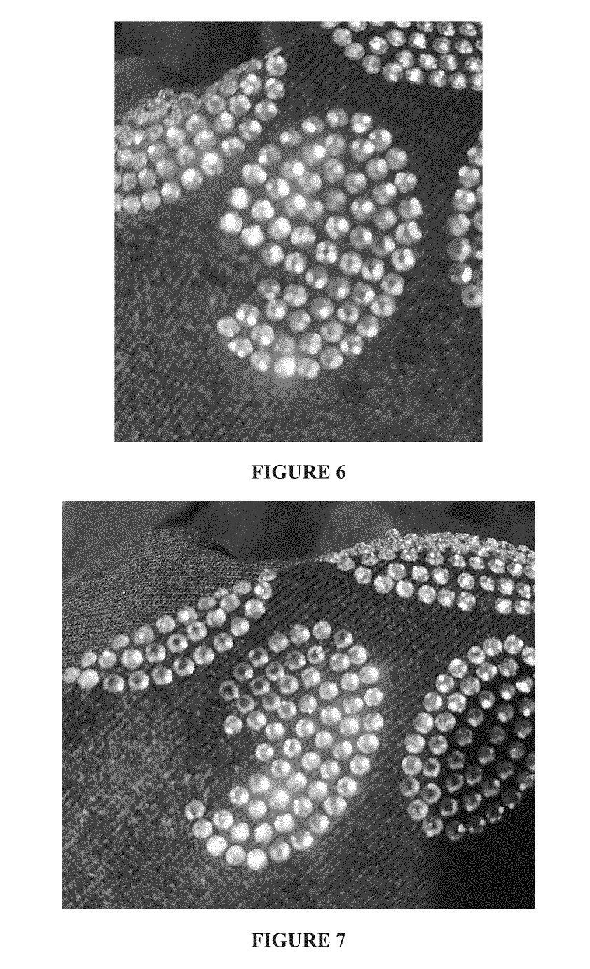

The effect of spot treating fabric was tested. Fabric with rhinestones was untreated (FIG. 4) or spot treated (FIG. 5) with phenyl alcohol. After five minutes, the rhinestones were removed from the spot-treated fabric with minimal pulling. No discoloration and no adhesive or adhesive residue were observed by the unaided eye (FIGS. 6-7).

1. A method of removing thermoplastic adhesive on fabric, the method comprising:
a. providing fabric that includes thermoplastic adhesive;
b. contacting the adhesive with adhesive remover that comprises aromatic solvent;
and
c. dissolving the adhesive.

2. The method of claim 1, wherein the fabric comprises decorative elements adhesively bonded on the fabric.

3. The method of claim 2, further comprises the steps of contacting the adhesive and the bonded decorative elements with the adhesive remover, and the step of dissolving the adhesive to remove the adhesive and the decorative element.

4. (canceled)

5. The method of claim 1, wherein the step of dissolving the adhesive is such that is it completely removes the adhesive and is not visible to the unaided eye.

6. The method of claim 1, wherein the step of contacting is by soaking, spraying, coating, brushing, and spot treating.

7. (canceled)

8. The method of claim 1, wherein the step of contacting is at room temperature.

9. The method of claim 1, wherein the aromatic solvent comprises arylalkyl alcohols.

10. The method of claim 9, wherein the aromatic arylalkyl alcohol comprises a phenyl alkyl alcohol.

11. The method of claim 10, wherein the phenylalkyl alcohol is a phenylethyl alcohol.

12. (canceled)

13. The method of claim 1, wherein the adhesive remover consists essentially of or consists of aromatic solvent.

14. The method of claim 1, wherein the thermoplastic adhesive is selected from polymeric adhesive comprising: ethylene-vinyl acetate copolymer resin, modified ethylene acetate vinyl copolymer resin, polyethylene, polypropylene, polyamide, polyester, polyvinyl chloride or derivatives thereof, or mixtures thereof.

15. The method of claim 1, wherein the thermoplastic adhesive comprises polyvinyl alcohol resin.

16. The method of claim 2, wherein the decorative elements comprise one or more of jewels, rhinestones, and gems.

17. (canceled)

18. (canceled)

19. A kit for decorating fabric, the kit comprising:
plurality of decorative elements to adhesively bond onto fabric;
thermoplastic adhesive for bonding the decorative elements onto the fabric; and adhesive remover.

20-22. (canceled)

23. The kit of claim 19, wherein the aromatic solvent comprises arylalkyl alcohols.

24. The kit of claim 23, wherein the arylalkyl alcohols comprises a phenylalkyl alcohol.

25. The kit of claim 24, wherein the phenylalkyl alcohol is a phenylethyl alcohol.

26. (canceled)

27. The kit of claim 19, wherein the adhesive comprises ethylene-vinyl acetate copolymer resin, modified ethylene acetate vinyl copolymer resin, polyethylene, polypropylene, polyamide, polyester, polyvinyl chloride, or derivatives thereof, or mixtures thereof.

28. The kit of claim 19, wherein the decorative elements comprise one or more of jewels, rhinestones, and gems.

29. The kit of claim 19, wherein the adhesive remover is supplied in a container containing at least 50, 60, 70, 80, 90, 95, 99, or 100 wt % aromatic solvent based on the total weight of the adhesive remover.

30-33. (canceled)
